(19) United States
(12) Patent Application Publication
(10) Pub. No.: US 2021/0364307 A1
(43) Pub. Date: Nov. 25, 2021

(54) Providing Additional Instructions for Difficult Maneuvers During Navigation

(71) Applicant: GOOGLE LLC, Mountain View, CA (US)

(72) Inventors: Aleks Kracun, Mountain View, CA (US); Matthew Sharifi, Mountain View, CA (US)

(21) Appl. No.: 17/252,260

(22) PCT Filed: Dec. 17, 2019
(86) PCT No.: PCT/US19/66893

§ 371 Date: Dec. 14, 2020

(51) Int. Cl. G01C 21/34; G01C 21/36; G06N 20/00

(52) U.S. Cl. CPC G01C 21/3484; G01C 21/3641; G06N 20/00; G01C 21/3647; G01C 21/3644

(57) ABSTRACT

A dataset descriptive of multiple locations and one or more maneuvers attempted by vehicles at these locations is received. A machine-learning model is trained using this dataset, so that the machine-learning model is configured to generate metrics of difficulty for the set of maneuvers. A query data including indications of a location and a maneuver to be executed by a vehicle at the location is received. The query data is applied to the machine-learning model to generate a metric of difficulty for the maneuver, and a navigation instruction for the maneuver is provided via a user interface, such that at least one parameter of the navigation instruction is selected based on the generated metric of difficulty.

### FIELD OF THE DISCLOSURE

The present disclosure generally relates to generating navigation instructions and, more particularly, to determining the difficulty of a maneuver and adjusting one or more parameters of a navigation instruction related to the maneuver in view of the determined difficulty.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Today, various software applications executing in computers, smartphones, etc. or embedded devices generate step-by-step navigation directions. Typically, a user specifies the starting point and the destination, and a software application obtains a navigation route from the starting point to the destination. The software application then generates navigation instructions as the user travels along the navigation route. For example, the software application can generate and vocalize the instruction “in 500 feet, turn left onto Main Street.”

In some cases, it may be desirable to modify a navigation instruction to increase or decrease the amount of detail, for example. However, automatically identifying maneuvers that are suitable for varying the level of detail, or locations at which such maneuvers occur, remains a difficult technical task.

### SUMMARY

Generally speaking, a system of this disclosure efficiently processes a dataset that describes various maneuvers (e.g., turns of certain types, merges, stops due to signage) drivers attempted and in some cases completed at respective geographic locations having certain identifiable parameters (e.g., intersections of certain types and with certain geometries), as well as data that describes locations at which no past maneuver data is available, to generate quantitative metrics of difficulty of the maneuvers at the corresponding locations. For the data pertaining to completed or attempted maneuvers, the dataset can include explicit indications of whether the drivers completed the maneuver successfully, the time it took the drivers to complete the maneuver, etc., or the system can derive this information from the other parameters in the dataset. In any case, for a certain location, the system can generate a quantitative metric of difficulty associated with making a certain maneuver. To this end, the system can train a machine learning model using the dataset and apply the model to various locations and maneuvers, including locations for which no prior data is available.

Depending on the implementation, the system can generate a quantitative metric of difficulty for all potential drivers or a particular driver by constructing a driver-specific model (e.g., when the driver expresses his or her desire for such a model, which can be stored locally on the driver's personal computing device).

The system can use the generated metric of difficulty of a maneuver at a certain location to vary one or more parameters of a navigation instruction related to the maneuver at the location. For example, the system can increase or decrease the level of detail and/or vary the timing of providing the navigation instruction. Further, the system can use the generated metric of difficulty to vary the navigation route that includes the maneuver at the location and, in some cases, navigate the user around the location. Still further, similar techniques can be implemented in an autonomous (or “self-driving”) vehicle to adjust the manner in which the autonomous vehicle executes a maneuver in view of the determined difficulty of the maneuver.

The system can apply similar techniques for assessing the difficulty of maneuvers for other modes of transport such as motorized two-wheelers (e.g., motorcycles) or non-motorized two-wheelers (e.g., bicycles).

One example embodiment of these techniques is a method for providing instructions. The method can be executed by one or more processors and includes receiving a dataset descriptive of multiple locations and a set of one or more maneuvers attempted by one or more vehicles at the locations. The method further includes training a machine-learning model using the dataset so as to configure the machine-learning model to generate metrics of difficulty for the set of maneuvers. Still further, the method includes receiving a query data including indications of a location and a maneuver to be executed by a vehicle at the location, applying the query data to the machine-learning model to generate a metric of difficulty for the maneuver, and providing, via a user interface, a navigation instruction for the maneuver, including selecting at least one parameter of the navigation instruction based on the generated metric of difficulty.

The machine-learning model may be trained in a supervised or unsupervised manner.

Each location may be indicative of a location of a road network, and further may be indicative of a road geometry at the location. For example, each location may be indicative of one or more road junctions of the road network at the location. The set of maneuvers may be maneuvers a vehicle can make with respect to the road network at a given location, such as, for example, turn left, turn right, go straight ahead, etc.

Metrics of difficulty for the set of maneuvers may be indicative of the probability that an operator of a vehicle will execute the maneuver successfully.

Selecting the at least one parameter based on the generated metric of difficulty may include, selecting a higher level of detail for the navigation instruction when the metric of difficulty exceeds a difficulty threshold, and selecting a lower level of detail for the navigation instruction when the metric of difficulty does not exceed the difficulty threshold. Providing a higher level of detail for the navigation instruction may comprise providing a greater number of instructions, and providing a lower level of detail for the navigation instruction may comprise providing a fewer number of instructions.

The at least one parameter may include a time interval between the providing the navigation instruction and the vehicle reaching the location, and selecting the at least one parameter based on the generated metric of difficulty may include selecting a longer time interval when the metric of difficulty exceeds the difficulty threshold, and selecting a shorter time interval when the metric of difficulty does not exceed the difficulty threshold.

In some implementations, the at least one parameter comprises both the level of detail for the navigation instruction and time interval between providing the navigation instruction and the vehicle reaching the location.

Selecting the at least one parameter may include determining whether the navigation instruction is to include a visual landmark based on the generated metric of difficulty.

Receiving the dataset may include receiving at least one (i) satellite imagery or (ii) street-level imagery for the plurality of locations and the location indicated in the query and the machine-learning model generates the metric of difficulty for the set of maneuvers in view of visual similarities between locations.

Receiving the dataset may include receiving at least one of (i) satellite imagery, (ii) map data, or (iii) vehicle sensor data for the plurality of locations and the location indicated in the query; training the machine-learning model includes applying, by the one or more processors, a feature extraction function to the data set to determine road geometry at the corresponding locations; and the machine-learning model generates the metric of difficulty for the set of maneuvers in view of similarities in road geometry between locations.

Receiving the dataset may include receiving indications of how long the one or more vehicles took to complete the corresponding maneuvers; and the machine-learning model generates the metric of difficulty for the maneuver in view of relative durations of the maneuvers at the respective locations.

Receiving the dataset may include receiving indications of navigation routes the one or more vehicles followed when attempting the corresponding maneuvers; and the machine-learning model generates the metric of difficulty for the set of maneuvers in view of whether the vehicles completed or omitted the corresponding maneuvers.

The indication location may not be referenced in the dataset.

The method may be implemented in a user device, wherein receiving the dataset includes receiving the dataset from a network server.

The method may be implemented in a network server, wherein providing the navigation instruction via the user interface includes sending the navigation instruction to a user device for display via the user interface.

The method may also be implemented in both a user device and a network server. For example, aspects relating to training the model may be carried out at the network server, and aspects relating to using the model may be carried out at the user device.

Another example embodiment of these techniques is a method in a user device for providing navigation instructions, the method comprising, receiving, by processing hardware via a user interface, a request to provide navigation instructions for traveling from a source to a destination and obtaining, by the processing hardware, a navigation route from the source to the destination, the navigation route including navigation instructions as provided by the method described above.

Another example embodiment of these techniques is a system including processing hardware and non-transitory computer-readable medium storing instructions. The instructions, when executed by the processing hardware, cause the system to execute the method above.

Still another example embodiment of these techniques is a method in a user device for providing navigation instructions. The method can be executed by processing hardware and includes receiving, via a user interface, a request to provide navigation instructions for traveling from a source to a destination, obtaining a navigation route from the source to the destination, where the navigation route includes a maneuver of a certain type at a location for which data descriptive of past maneuvers performed at the location is unavailable, and providing a navigation instruction for the location. The navigation instruction includes at least one parameter modified in view of a level of difficulty of the maneuver, where the level of difficulty is determined based on one or more metrics of similarity of the maneuver to maneuvers of the same type performed at other locations.

The at least one parameter modified in view of the level of difficulty may be a level of detail of the navigation instruction. The at least one parameter may be modified in view of the level of difficulty is a time interval between the providing the navigation instruction and the vehicle reaching the location.

Another example embodiment of these techniques is a user device including processing hardware and non-transitory computer-readable medium storing instructions. The instructions, when executed by the processing hardware, cause the system to execute the method above.

Optional features of one embodiment may be combined with any other embodiment where appropriate.

### BRIEF DESCRIPTION OF THE DRAWINGS

FIG. 1 illustrates an example computing environment in which techniques for generating navigation instructions in view of quantitative metrics of difficulty of maneuvers can be implemented;

FIG. 2 is a flow diagram of an example method of using a machine-learning model to generate metrics of difficulty of maneuvers when generating navigation instructions, which can be implemented in the computing environment of FIG. 1;

FIG. 3 illustrates a set of four right turn maneuvers at respective geographic locations that have similarities in roadway layouts, which the machine-learning model implemented in the environment of FIG. 1 can process;

FIG. 4 illustrates another set of four right turn maneuvers at geographic locations that have similarities in roadway layouts which the machine-learning model implemented in the environment of FIG. 1 can process;

FIG. 5 illustrates a set of four left turn maneuvers at geographic locations that include traffic circles, which the machine-learning model implemented in the environment of FIG. 1 can process;

FIG. 6 illustrates a set of four left turn maneuvers at geographic locations where terrain information is indicated at the locations, which the machine-learning model implemented in the environment of FIG. 1 can process;

FIG. 7 illustrates four street-level frames corresponding to a set of similar left turn maneuvers at similar locations, which the machine-learning model implemented in the environment of FIG. 1 can process;

FIG. 8 illustrates four street-level frames in the context of four similar right turns, which the machine-learning model implemented in the environment of FIG. 1 can process; and

FIG. 9 illustrates four remediation maneuvers that may be executed by vehicle operators in the aftermath of missing a left turn, using which the machine-learning model implemented in the environment of FIG. 1 can assess the difficulty of the maneuver.

### DETAILED DESCRIPTION

### Overview

The navigation system and methods of this disclosure can provide navigation instructions to a user operating a vehicle in view of metrics of difficulty of maneuvers. The navigation system also can provide these indications to an autonomous (or “self-driving”) vehicle, but for simplicity the examples below refer to human users, or “operators” of vehicles such as cars, trucks, motorcycles, bicycles, etc. The navigation system can generate “subjective” metrics of difficulty for a particular user (e.g., a traffic circle is a difficult maneuver for user X) and/or “objective” metrics of difficulty applicable to all users (e.g., the left turn at a particular intersection is difficult due to the angle at which the roads intersect). As discussed below, the navigation system in various implementations automatically determines relationships between maneuvers, locations, driver behavior, etc. using machine-learning techniques.

The metric of difficulty for a maneuver in some cases indicates the probability that an operator will execute the maneuver successfully. In some implementations or scenarios, the success of executing a maneuver can correspond to completing the maneuver with no time restriction rather than missing the maneuver and subsequently taking an alternative route. In other implementations or scenarios, the success of executing a maneuver can correspond to safely completing the maneuver within a certain amount of time. For example, if an operator of a vehicle turns very abruptly, having nearly missed a turn or, conversely, slows down beyond a certain threshold of an expected delay, the navigation system can determine that the operator has completed the maneuver unsuccessfully. The navigation system in some cases can generate a metric of difficulty for a maneuver specifically for the environmental conditions (e.g., time, weather, amount of traffic) at the current or projected time of executing the maneuver.

After generating a metric of difficulty, and in order to increase the probability of success for a given maneuver, the navigation system can adjust a navigation instruction for the maneuver and/or the manner in which the navigation system provides the navigation instruction to the user. For example, the navigation system can increase the number of prompts related to the maneuver for the user. As a more specific example, instead of generating a single warning at a certain distance before the turn, such as “Turn right in 200 feet at Linden Avenue,” the navigation system may generate a series of prompts for the same maneuver, e.g., “Turn right in 200 feet at Linden Avenue; your turn is coming up after the next turn; prepare to turn right; turn right onto Linden Avenue.” Additionally or alternatively, the navigation system can increase the level detail for the single navigation instruction. Still further, the navigation system can generate a separate prompt to advise the user of the difficulty of the maneuver. The more detailed instructions may improve user experience, mitigate loss of life, health, and property, as well as improve the functionality of the roadways by decreasing congestion due to poorly executed maneuvers.

In some of the implementations, the system utilizes a machine-learning model to generate these metrics. In particular, a machine learning system can implement techniques for generating metrics of difficulty and, in some cases, determine how and when the navigation system should provide additional instructions for difficult maneuvers in an efficient manner so as to efficiently utilize computing resources and communication bandwidth.

A machine-learning model of this disclosure can generate a metric of probability for successful execution of a prescribed maneuver or, more generally, a metric of difficulty for a maneuver at a certain location, even in the absence of history data descriptive of past execution of the maneuver at that location. To that end, the navigation system can train the machine-learning model using a dataset descriptive of a number of locations and maneuvers to be executed by a vehicle at the number of locations, where the locations in the training dataset need not include the location of the prescribed maneuver. The accuracy of the machine-learning model in general increases when the training data includes information about a large number of maneuvers analogous to the prescribed maneuver at a large number of locations similar to the location of the prescribed maneuver.

As discussed in more detail below, the system of this disclosure can train a machine-learning model to efficiently detect similarities in topology, line-of-sight obstructions, and other factors that affect the ability of a driver to maneuver, and generate predictions for locations and maneuvers to be performed at these locations.

In some cases, the metric of difficulty of a maneuver generated by the machine-learning model is more accurate than an estimate of probability of success and/or maneuver difficulty based solely on statistics of past success (e.g., missed maneuver, delays, unsafe or hurried execution) for the maneuver at the corresponding location. For example, the maneuver can be the right turn at a certain intersection. Although it is possible to estimate the probability of successfully executing the turn by counting the number of times drivers missed this turn in the past and counting the number of times drivers attempted this turn, this type of analysis may yield inaccurate estimates unless data for a large number of instances of maneuvering through the intersection is available, which is not always the case for many locations. On the other hand, the navigation system of this disclosure can identify similarities between locations and in some cases can apply data for a large number of right turns attempted at locations similar to the location in question (and, if desired, under similar conditions and/or circumstances), and thereby considerably improve the estimate of difficulty of a maneuver at this location.

### Example Computing Environment

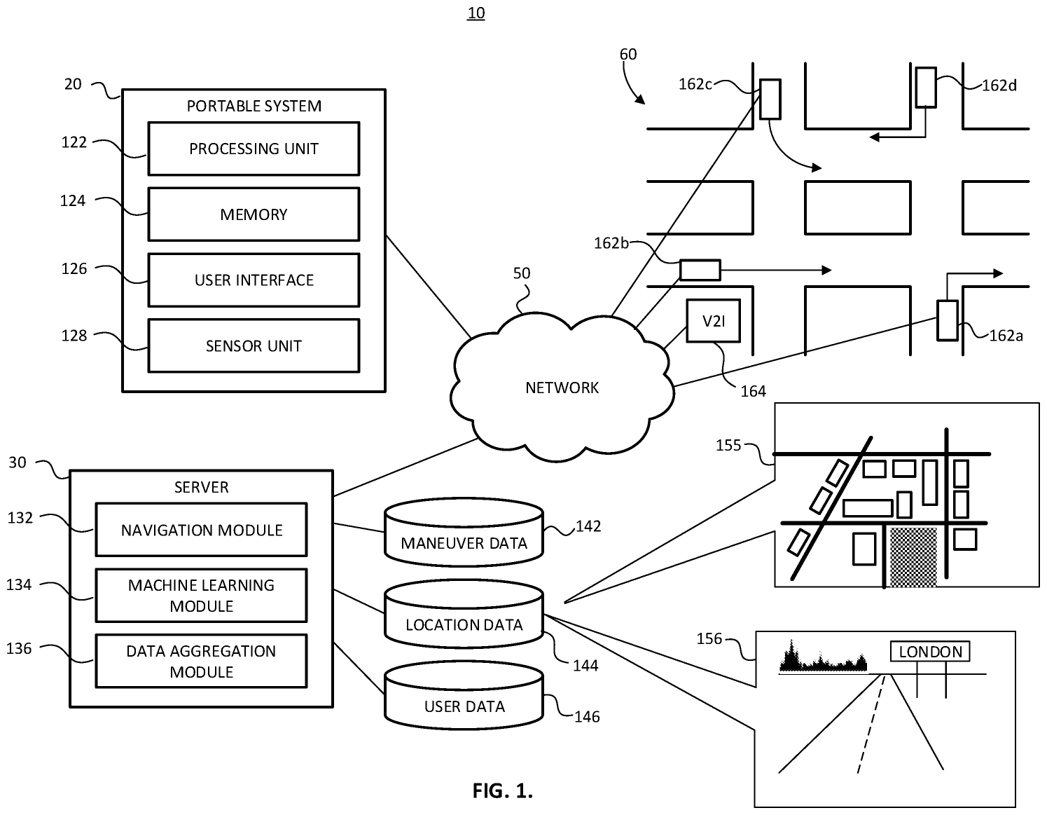

FIG. 1 illustrates an example environment 10 in which techniques for generating metrics of difficulty of maneuvers can be implemented. The environment 10 includes a portable system 20 and a server system 30 interconnected via a communication network 50. Furthermore, the portable system 20 and/or the server system 30 may be connected via the communication network 50 with a vehicle transportation system 60. A navigation system operating in the environment 10 may be implemented using the portable system 20, the server system 30, or partially in the portable system 20 and partially in the server system 30. The navigation system may collect data for training a machine-learning model from the vehicle transportation system 60.

The portable system 20 may include a portable electronic device such as a smartphone, a wearable device such as a smartwatch or a head-mounted display, or a tablet computer for example. In some implementations or scenarios, the portable system 20 also includes components embedded or mounted in a vehicle. For example, a driver (or, equivalently, operator) of a vehicle equipped with electronic components such as a head unit with a touchscreen may use her smartphone for navigation. The smartphone may connect to the head unit of the vehicle via a short-range communication link such as Bluetooth® to access the sensors of the vehicle and/or to project the navigation instructions onto the screen of the head unit. In general, modules of a portable or wearable user device, modules of a vehicle, and external devices or modules of devices may operate as components of the portable system 20.

The portable system 20 may include a processing module 122, comprising one or more processors which may include one or more central processing units (CPUs), one or more graphics processing units (GPUs) for efficiently rendering graphics content, field-programmable gate arrays (FPGAs), application-specific integrated circuits (ASICs), or any other suitable type of processing hardware. Further, the portable system 20 may include a memory 124 made up of persistent (e.g., a hard disk, a flash drive) and/or non-persistent (e.g., RAM) components. The portable system 20 further includes a user interface 126. Depending on the scenario, the user interface 126 may correspond to the user interface of the portable electronic device or the user interface of the vehicle. In either case, the user interface 128 may include one or more input components such as a touchscreen, a microphone, a keyboard, etc. as well as one or more output components such as a screen or speaker. Still further, the portable system 20 may include a sensor unit 128. The sensor unit 128 may interface with the sensors of the vehicle and/or include sensors such as one or more accelerometers, a global positioning receiver (GPS), and/or other sensors that may be used in navigation.

The portable system 20 may communicate with the server system 30 via the network 50, which may be a wide-area network such as the Internet. The server system 50 may be implemented in one more server devices, including devices distributed over multiple geographic locations. The server system 30 may implement a navigation module 132, a machine learning module 134, and a data aggregation module 136. The components 132-136 may be implemented using any suitable combination of hardware, firmware, and software. The hardware of the server system 30 may include one or more processors, such as one or more CPUs, one or more GPUs, FPGAs, ASICs, or any other suitable type of processing hardware. Further, the server system 30 may be fully or partially implemented in the cloud. The server system 30 may access databases such as a maneuver database 142, a location database 144, and a user profile database 146, which may be implemented using any suitable data storage and access techniques.

In operation, the navigation module 132 may receive a request for navigation instructions from the portable system 20. The request may include a source, a destination, and one or more user preferences such as a request to avoid toll roads, for example. The navigation module 132 in response may retrieve road geometry data, road and intersection restrictions (e.g., one-way, no left turn), road type data (e.g., highway, local road), speed limit data, etc. from the location database 144 to generate a route from the source to the destination. In some implementations, the navigation module 132 also obtains live traffic data when selecting the best route. In addition to the best, or “primary,” route, the navigation module 132 may generate one or several alternate routes.

In addition to road data, the location database 144 may store descriptions of geometry and location indications for various natural geographic features such as rivers, mountains, and forests, as well as artificial geographic features such buildings and parks. The location database 144 may include, among other data, vector graphics data, raster image data, acoustic data, radio spectrum data, and text data. In an example implementation, the location database 144 includes map data 155 and street-level imagery data 156. The map data 155, in turn, may include satellite imagery and/or schematic data derived based on, for example, classifying, reducing and/or compressing satellite imagery data and organizing the resulting map data 155 into map tiles. The location database 144 may organize map tiles into a traversable data structure such as a quadtree. The street-level imagery data 156 may include collections of image frames indicative of driver or vehicle operator perspective. In some implementations, the street-level imagery data 156 may include a classified, reduced, and/or compressed representation of image frames. The location database 144 may organize street-level imagery data 156 in suitable data structures, such as trees.

The navigation module 132 of the server 30 may cooperate with the portable system 20 to generate and provide, by the corresponding one or more processors, a sequence of navigation instructions based on the one or more generated routes. Each route may comprise one or more maneuvers that include, for example, going straight, right turns, left turns, right merges, left merges, U-turns, and/or any other suitable maneuvers. The navigation module 132 may generate a sequence of instructions based on the one or more generated routes and communicate the instructions to the portable system 20. The instructions may include text, audio, or both. The portable system 20 may render, by way of the user interface 126, the instructions as visible, auditory, and/or haptic signals to the driver associated with the portable system 20. Examples of navigation instructions include prompts for executing maneuvers, such as “in 500 feet, turn right on Elm St.” and “continue straight for four miles.” The navigation module 132 and/or the portable system 20 may implement natural language generation techniques to construct these and similar phrases, in the language of the driver associated with the portable system 20. As discussed in more detail below, the navigation module 132 and/or software components implemented in the portable system 20 may generate initial navigation instructions and adjust the instructions while the portable system 20 is en route.

The navigation module 132 and/or the portable system 20 may generate and provide instructions with fewer or more details, with the level of detail based at least in part on generated metrics of difficulty of the maneuvers in the corresponding route. As a more specific example, the navigation module 132 can generate navigation instructions that are more detailed when the metric of difficulty exceeds a certain threshold, and generate navigation instructions that are less detailed when the metric of difficulty is at or below the certain threshold. The navigation module 132 can receive these from the machine learning module 134.

The machine learning module 134 can assess the difficulty of the maneuvers in a route at least in part by using machine-learning models. The machine learning module 134 may receive query data including indications of a location, a maneuver intended for execution at the location by an operator, and apply the query data (e.g., to one or more machine-learning models) to generate a metric of difficulty for the maneuver.

The machine learning module 134 may be implemented as one or more software components on the one or more processors of the server system 30. In some implementations, the machine learning module 134 includes dedicated hardware components, such as GPUs, FPGAs, or any other suitable hardware for efficient implementation of machine learning models. At least some of the components of the machine learning module 134 may be implemented in a distributed architecture, including, for example, cloud computing.

The machine learning models implemented with the machine learning module 134 may use regression or classification models, generating a metric as a number (e.g., between zero and one) or a class (e.g., highly difficult, somewhat difficult, somewhat easy, or very easy), respectively. The machine learning models may include neural networks, such as convolutional neural networks (CNNs) or recursive neural networks (RNNs), decision tree algorithms, such as random forests, clustering algorithms, or any other suitable techniques and their combinations.

The machine learning module 134 may receive training data from the maneuver database 142, the location database 144, and/or the user database 146. In other implementations, a single database may combine the functionalities of the maneuver database 142, the location database 144, and/or the user database 146, and/or additional databases may provide data to the server 30.

The data aggregation module 136 may populate the databases 142-146 based on receiving, by the one or more processors of the server system 30, a dataset descriptive of locations and maneuvers to be executed by a vehicle at the corresponding locations. The data aggregation module 136 may collect information from the vehicle transportation system 60.

With continued reference to FIG. 1, the example vehicle transportation system 60 includes vehicles 162a-d, each executing a corresponding maneuver in a transportation environment of a geographic area. Each of the vehicles 162 a-d may include a portable system, analogous to the portable system 20, and/or additional sensor or communication devices that may measure, record, and communicate data associated with the maneuvers executed by the vehicles 162 a-d. At least some of the vehicles 162 a-d may be equipped with vehicle-to-vehicle (V2V) devices and communicate maneuver and location-related data to each other. Additionally or alternatively, the vehicle transportation system 60 may include vehicle-to-infrastructure (V2I) devices or modules (e.g., V2I module 164) for sensing and collecting maneuver and location-related data.

The data aggregation module 136 may also collect information from satellite, airborne, and/or any other suitable platform for monitoring traffic and/or roadway use by vehicles. In some implementations and/or applications, the data aggregation module 136 anonymizes the collected data to ensure compliance with all applicable laws, ethical norms, and/or user expectations. Additionally or alternatively, the devices, modules, and system supplying the data to the aggregation module 136 may anonymize the collected data.

The data aggregation module 136 may collect, for example, with express permission of affected users of the vehicle transportation system 60, data about the affected users associated with maneuvers. The data about users may be stored in the user database 146 and may be associated with the data records in the maneuver data 142 and/or the location database 144.

The machine learning module 132 may train the machine learning models using the data collected by the data aggregation module 136 and stored in associated records with the maneuver database 142, the location database 144, and the user database 146. The records of the databases 142-146 may include information about or indications of a variety of conditions associated with each maneuver. In some implementations and/or circumstances, the indications of conditions include at least one of the following: lighting (determined for example using sensors installed in vehicles or sensors external to vehicles, such as satellites monitoring weather conditions in real time); visibility (determined for example using built-in dashboard cameras or portable devices mounted on the dashboard); current road conditions (e.g., current repairs or presence of potholes determined using crowdsourcing techniques or based on IMUs of vehicles for example); precipitation (determined using vehicle sensors or a real-time weather service for example); and traffic conditions (determined using for example crowdsourcing techniques). When a user indicates his or her willingness to provide certain type of data to the machine learning module 132, the indications of conditions may include the type of the vehicle the operator is driving (e.g., a two-wheeler, a car) and/or familiarity of an operator of the vehicle with the maneuver to be executed by the vehicle (determined, for example, based on the number of times the operator previously executed the maneuver).

Generally speaking, the training of machine learning models implemented with the machine learning module 132 creates an association between one or more indications of a location paired with a maneuver intended for execution at that location by an operator and an indication of probability that the operator will execute the maneuver successfully and/or a metric of difficulty of the maneuver. In other words, upon training, the machine learning module 132 may take, as input, query data including indications of (i) a location and (ii) a maneuver intended for execution at the location by an operator, and generate a metric of probability based at least in part on that query data. The query data may additionally include indications of conditions associated with the location, the maneuver, and or the operator associated with the query. The indications of conditions may be associated with the time at which the maneuver may be executed. The conditions may be dynamic, varying quickly (e.g., substantially different after 1, 2, 5, 10, 20, 50 minutes) or slowly (e.g., substantially similar for a duration of 1, 2, 5, 10, 20, 50 hours or longer). The evaluation of probability may vary with the conditions and, consequently, the evaluation may be updated en route as the conditions change.

The indications of the conditions used in training the machine learning models or in the query may include information about lighting, visibility, road conditions, precipitation, and/or traffic conditions. For example, ambient illumination or light levels may be recorded by sensors disposed in the vehicles and/or in the infrastructure. In some implementations, applications, and/or situations, the data aggregation module 136 and/or the sources of information from which it receives data may estimate the lighting levels based at least in part on local time and location (e.g., latitude, longitude, elevation). Determining visibility may include measurements using sensors on the vehicles 162 a-d within the V2I module 164 and/or obtaining the levels of air pollution from public or private databased, meteorological services, or any other suitable sources. Likewise, determining road conditions and/or precipitation (e.g., intensity of fog, rain, snow, sleet, or hail) may include measurements using sensors on the vehicles 162 a-d within the V2I module 164 and/or meteorological services, as well as any other suitable sources. Determining traffic conditions, on the other hand, may include obtaining information from V2V or V2I devices and/or traffic reporting services.

Additionally or alternatively, the indications of the conditions used in training the machine learning models or in the query may include, for each maneuver, the type of vehicle and/or familiarity of an operator of the vehicle with the maneuver to be executed by the vehicle (determined, for example, based on the number of times the operator previously executed the maneuver), for example. The difficulty of executing, for example, a right turn at a narrow intersection may depend, among other factors, on whether the vehicle is a two-wheeler or a car (and, in some implementation, whether the car is small or large).

The machine learning module 134 may evaluate probabilities for different sets of candidate navigation instructions and choose the set of instructions that optimizes a certain cost function for example. The optimization of the cost function may be equivalent to maximizing the probability of successful execution of the maneuver, or may trade off some reduction in the probability of success for other considerations.

The considerations in evaluating the cost function and choosing a set of instructions may include predicted intrusiveness of additional instructions (e.g., a probability that the operator may find the additional instructions annoying), potential consequences in failing the execution of the maneuver, computational complexity of the optimization, power management within the portable system 20, user preferences, and/or other suitable considerations. For example, if missing a highway exit would result in a long detour, even a marginal improvement in the probability of successfully executing the merge maneuver at the highway exit may warrant additional navigation instructions (e.g., spaced reminders, lane-change instructions). On the other hand, when a detour resulting from missing a maneuver adds substantially negligible time to the route (e.g., less than 0.1, 0.2, 0.5, 1, 2% of total route duration or a delay below a threshold delay) and/or user settings indicate a preference for sparse instructions, the navigation module 132 and/or the portable system 20 may withhold additional navigation instructions although they may increase the probability of successfully executing the maneuver.

Generating a metric of difficulty for a maneuver at a certain location can include computing the statistics of successful execution of the same maneuver at the same location by the same and/or other vehicle operators. However, in some situations, the statistics computed solely on the basis of identical maneuvers at the same locations computed may result in an inaccurate estimate of probability. The data at the location of interest may be sparse, particularly when taken into account limiting the data to the maneuvers attempted under similar conditions (e.g., driver unfamiliar with the route making a left turn onto a particular small street, after going straight for over 5 minutes, on a rainy night, moving at 32-38 miles per hour). The machine learning module of this disclosure, on the other hand, may take into account statistics from many similar maneuvers at similar locations, attempted under similar circumstances. A suitably-configured and trained machine-learning model may give more weight to statistics of similar maneuver and condition combinations than to less similar maneuver and condition combinations, as discussed in more detail below.

### Example Method of Determining and Applying a Metric of Difficulty for a Maneuver

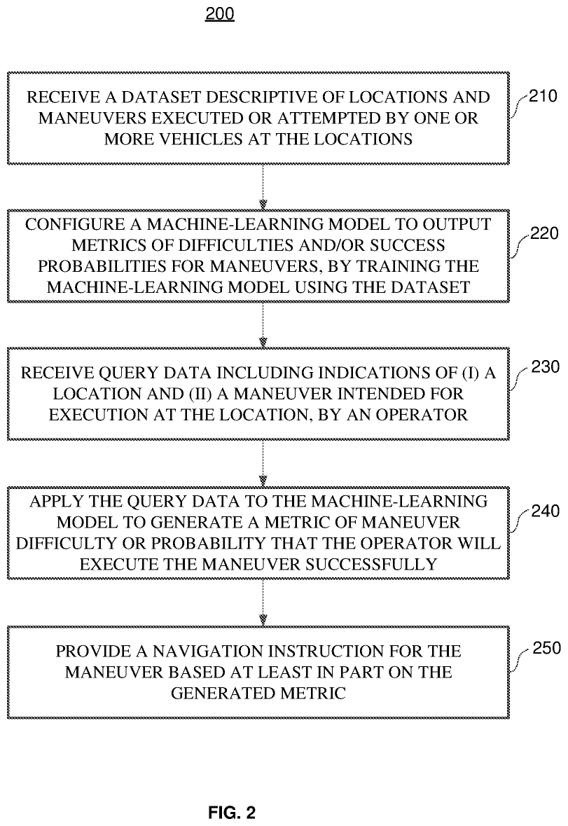

FIG. 2 is a flowchart depicting a method 200 of providing navigation instructions that can be implemented in the portable system 20 and the server system 30 of FIG. 1, for example. As a more specific example, the machine learning module 134 can at least partially implement the method 200 to train a machine learning model using data retrieved from the databases 142, 144, 146, etc., and the navigation module 132 can apply the machine learning model to generate navigation instructions. More generally, any suitable computer system capable of training and applying machine-learning models to navigation data, disposed within a mobile platform, on a server, or distributed among multiple computing components may implement the method 200 of providing navigation instructions.

At block 210, the method 200 includes receiving a dataset that describes locations and maneuvers executed or attempted by one or more vehicles at these locations. For example, in the environment 10 illustrated in FIG. 1, the portable system 20 and/or the server 30 may receive at least portions of the dataset from the vehicle transportation system 60 via the communication network 50. Additionally or alternatively, a user can supply some portions of the dataset (particularly when the machine learning module 134 constructs a user-specific model), or the server 30 can obtain at least a portion of the dataset from a third-party server. The server 30 can obtain some data from the maneuver database 142, the location database 144, and/or the user database maneuver 146.

At block 220, the method 200 includes configuring a machine-learning model to output probabilities of executing the plurality of maneuvers successfully by training the machine-learning model using the dataset. The machine-learning model can associate these probabilities with metrics of difficulty for the maneuvers (e.g., a lower probability of success indicates higher difficulty) or derive metrics of difficulty from the probabilities of success. The machine learning model may be implemented on a server (e.g., the machine learning module 134 of the server 30 in FIG. 1) or in a portable system (e.g., within the portable system 20 in FIG. 1). As discussed with reference to FIG. 1, a machine learning model may be a regression model, a classification model, or any suitable combination of regression and classification models. In some implementations, a system executing the method 200 may configure and train multiple machine learning models, e.g., for various users, various environmental conditions, various times of day, etc. Further, as described in more details below, the method 200 can include applying a combination of models to determine an appropriate level of detail, the timing, etc. for navigation instructions. The server 30 of FIG. 1, for example, may configure the machine learning model using the machine learning module 134, possibly using the data aggregation module 136, or any other suitable hardware and/or software module. In some implementations, a machine learning module that configures the machine learning model may be implemented at least in part on a portable system (e.g. the portable system 20 in FIG. 1), may be distributed across multiple servers and/or portable systems, and/or may be implemented in a cloud.

Configuring a machine learning model may include selecting features descriptive of locations, maneuvers, and/or conditions under which the maneuvers were executed at the locations. The conditions for a given maneuver may be descriptive or indicative of an environment (e.g., road conditions, traffic, weather, lighting). Additionally or alternatively, configuring a machine learning model may include selecting a type of model (e.g., a random forest, a convolutional neural network) and choosing values for parameters and/or hyper-parameters of the chosen model type (e.g., number of trees, depth of trees, number on layers in a network, layer types, layer sizes, or any other suitable parameters and/or hyper-parameters).

At block 230, the method 200 includes receiving query data including indications of (i) a location and (ii) a maneuver intended for execution at the location, by an operator. In some implementations, the machine learning module 134 of the server 30 may receive the query data sent, for example, by the portable system 20 of FIG. 1. In some implementations, the navigation module 132 of the server 30 may generate the query and send the query data to the machine learning module 134. The navigation module 134 may be at least in part implemented on the portable system 20 or on a cloud. Consequently, the machine learning module 134, which may itself be distributed, may receive the query data over a network (e.g., the network 50) from any suitable source.

The maneuver indicated in the query may correspond to a location for which data descriptive of past maneuvers performed at the location is unavailable. The machine learning model for generating the metric of difficulty in some implementations predicts the metric of difficulty based on the features of the location and the learned correlation between location features and metrics of difficulty and/or success.

The query data indicative of the maneuver intended for execution may include an indication of whether the intended maneuver is a right turn, a left turn, a U-turn, a right merge, or a left merge. The query data indicative of the maneuver may include information indicative of additional or alternative maneuver classification. For example, a right turn (or a left turn) may be indicated as sharp, slight, or labeled in a different manner. Merge maneuvers may include indications whether the merges are lane changes, on-ramps, off-ramps, or include any other suitable indications (e.g., speed changes associated with merges).

In some implementations, the query data also may include indications of conditions under which the maneuver is expected be executed. Depending on the implementation or scenario, the indications of conditions may specify the conditions with complete certain or can specify probability of certain conditions occurring. The conditions reflected in the data may include indications of how much lighting is available, the visibility at the time of the maneuver, road conditions, the amount of traffic, the amount and kind of precipitation (e.g., rain, snow) or concentration (e.g., fog, smog) at the time of executing the maneuver, etc. Additionally or alternatively, the indications of conditions can include the type of the vehicle the operator is using, such as a two-wheeler or a car, and/or familiarity of the operator with the maneuver to be executed.

In some implementations, the machine learning module 134 trains the machine learning model using indications of conditions as features of maneuvers. In other implementations, one machine learning model (referred to as the first machine learning model for the purpose of the example) may generate an output based on the maneuver and the location data, while a separate algorithm or a machine learning model may evaluate the effect of the conditions on the output of the first machine learning model.

At block 240, the method 200 includes applying the query data to the machine-learning model to generate a metric of probability that the operator will execute the maneuver successfully. For example, the machine learning module 134 of FIG. 1 or any other suitable module implemented at least in part on a server (e.g., server 30), a portable system (e.g., portable system 20), or a cloud, may format or pre-process the query data into an input vector or different input vectors for one or more machine learning models. The one or more machine learning models may output one or more metrics that by themselves or in combination may be post-processed to generate a metric of probability that the maneuver in question will be executed at the location in question by the operator in question successfully.

The probability may be conditional on a set of navigation instructions that the operator would receive. More specifically, one or more values of probability may be generated for corresponding one or more navigation instruction sets. For example, the system (e.g., the server 30) may determine that, with minimal instructions, an operator is unlikely (a metric indicates low probability) to execute a maneuver successfully (e.g., will miss a highway exit). On the other hand, the system may determine that with additional instructions, the probability of successful execution of the maneuver in question significantly increases (e.g., the operator would be likely to exit the highway safely and successfully).

At block 250, the method 200 includes providing a navigation instruction for the maneuver at least in part based on the generated metric of probability. In some implementations, a navigation module (e.g., navigation module 132), upon receiving one or more generated metrics of probability corresponding to one or more sets of potential navigation instructions, may generate and provide a navigation instruction for eventual delivery to the operator of the vehicle corresponding to the query data. In some implementations, a superset of navigation instructions is loaded onto a portable system (e.g., memory 124 of the portable system 20) that may be disposed in the vehicle at the time that navigation is requested by the operator. Each of the maneuvers in the planned route may be evaluated (using a machine learning model) for probability of success before the instructions are loaded onto the portable system, and the instructions may be adapted, possibly iteratively, in view of the generated probabilities of success. For example, the navigation system can replace the short instruction “Turn right on County Road” with a longer instruction “County Road is approaching in half a mile. Prepare to turn right on County Road in 300 feet. Make the approaching right turn onto County Road,” if the metric of difficulty for the corresponding maneuver exceeds a certain threshold.

In some cases, the navigation system of FIG. 1 can vary the timing of the navigation instruction in accordance with the metric of difficulty. For example, the navigation system can generate multiple instances of a certain navigation instruction when the vehicle approaches the location of the next maneuver, and can vary the time interval between the instances in accordance with the metric of difficulty. As a more specific example, the navigation system can repeat a certain navigation instructions five seconds after the first instance if the metric of difficulty exceeds a certain threshold, or seven seconds after the first instance if the metric of difficulty does not exceed the threshold. Alternatively, the navigation system can vary the duration of the interval between providing a navigation instruction and the vehicle reaching the location of the maneuver. Thus, the navigation system can provide the navigation instruction earlier (and thereby make the interval longer) when the metric of difficulty exceeds a certain threshold, or sooner (and thereby make the interval shorter) when the metric of difficulty does not exceed the threshold.

Still further, the navigation system in some cases can augment navigation instructions with visual landmarks when the metric of difficulty exceeds a certain threshold. For a certain difficult maneuver at a certain location, the navigation system can supplement the navigation instructions with a reference to a distinctive and prominent visual landmark (e.g., “turn left by the red billboard”).

In some implementations, the navigation module 132 can dynamically change navigation instructions for an operator in view of information obtained along the route. Additionally or alternatively, the navigation system may adjust instructions dynamically at least in part based on a change in conditions, such as the conditions described above. For example, a change in the weather, affecting visibility, road condition, and/or precipitation may affect the probability of success in a given maneuver, as generated by the navigation system using a machine learning model. An onset of fog may prompt additional details in instructions, particularly for the maneuvers that are more susceptible to changes in visibility, as determined by a machine learning model. In another example, a navigation system may determine that a change has occurred in a condition of the vehicle, and/or any other suitable conditions in which the intended maneuver would be performed. In some implementations, a portable unit (e.g., portable unit 20) may detect a change in conditions, for example, using the sensor unit 128. The navigation system can obtain information indicative of a change in conditions from any suitable source (e.g., the V2I module 164 in FIG. 1), and in response the navigation system can reevaluate the probability of successfully executing a maneuver and/or second the level of detail of the instructions to be provided to an operator.

The navigation system may provide (e.g., via the user interface 126 of the portable system 20) instructions to the operator via one or more signal modes (e.g., visual, auditory, haptic or any other suitable signals). In some implementations, the navigation system may choose the one or more signal modes and/or one or more signal amplitudes based at least in part on one or more metrics of probability (of successful execution of a maneuver) generated using one or more machine learning models. For example, in some implementations and/or scenarios (e.g., an option chosen by an operator), the navigation system may provide a navigation instruction with a synthesized voice command only when the generated metric of probability of successfully executing a corresponding maneuver falls below a threshold.

### Example Scenarios and Additional Implementation Details

For further clarity, several example scenarios are discussed below with reference to the example navigation system of FIG. 1. The machine learning module 134 in these scenarios generates metrics of difficulty for a maneuver by training a model to recognize visual similarities (e.g., using satellite imagery or street-level imagery), similarities in road geometry (e.g., using schematic map data, satellite imagery, data from vehicle sensors).

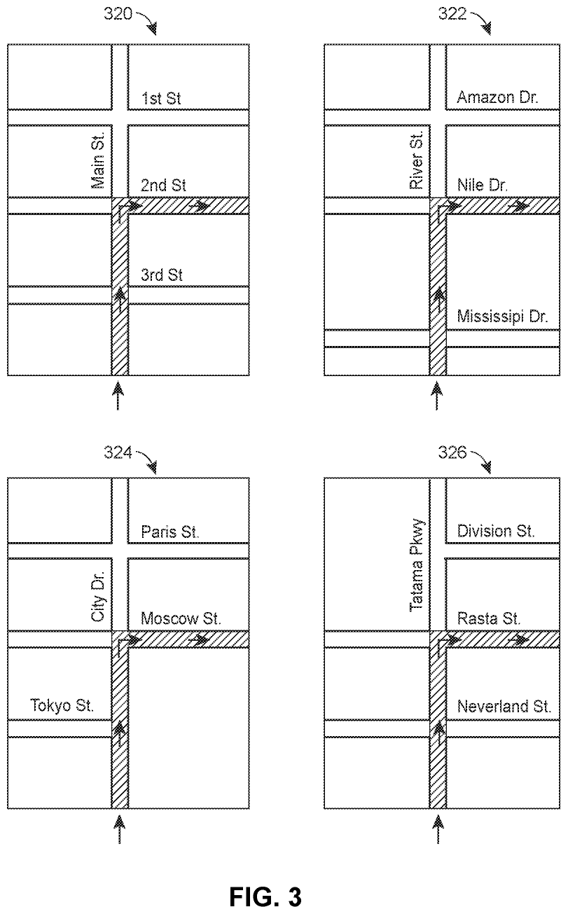

FIG. 3 illustrates a set of four right turn maneuvers at geographic locations 320-326 that have similarities in roadway layouts which the machine learning module 134 can learn to automatically recognize. For each maneuver and/or type of maneuver (or, similarly maneuver type, maneuver class, sort of maneuver) location information may encompass a suitable geographic area that may include the intersection at which a maneuver is executed and an area within suitable distance margins. The suitable distance margins may be different along the different directions with respect to the approach direction. The margins may depend on the type of geographic location (e.g., urban, suburban, rural), the speed limit, and/or other suitable factors. In some implementations, the distance margins may depend on the conditions (e.g., light, precipitation) under which the maneuvers are executed.

In some implementation, a distinct location may correspond to a specific intersection and approach. For example, maneuver 320 may be defined as approaching 2^{nd} street along Main St. from 3^{rd} street. Approaching the same intersection from the side of 1^{st} street may be defined as a different location for a similar maneuver. Some types of maneuvers (e.g., U-turns, lane-changes) may not be associated with intersections. Correspondingly, the geographic areas corresponding to such maneuvers may have smaller margins transverse to the approach direction than geographic areas corresponding to turns.

A machine learning model implemented by the machine learning module 134 may assimilate, through training, maneuver data at each of the locations 320-326 to more accurately generate a metric of probability that an operator will successfully execute a right turn at any one of these four locations 320-326 and/or other locations. The training of the machine learning model and the application of it to generate metrics of probability of success for new maneuvers intended for execution may include, as model inputs, location data and/or conditions under which maneuvers were and/or would be executed.

Model inputs descriptive of the locations 320-326 (i.e., location data) may include geographical coordinates (e.g., latitude, longitude, elevation), map data, satellite images, street-level imagery data, speed limits, roadway classifications (e.g., local street, major artery), local environment classifications (e.g., dense urban, suburban, rural), and/or other suitable data. Additionally or alternatively, model inputs may include data indicative of street or roadway configurations which the machine learning module 134 can determine based on map data, satellite data, and/or another suitable source, for example.

Further, model inputs for each of the right turns maneuvers at the illustrated locations 320-326 may include data indicative and/or descriptive of conditions associated with each maneuver. The indications of conditions may include metrics or categories for lighting, visibility, road condition, and/or precipitation. Additionally or alternatively, the indications of conditions may include metrics or categories for type of the vehicle, condition of the vehicle, familiarity of an operator of the vehicle with the maneuver to be executed by the vehicle

The model inputs may be categorical (e.g., good, bad, very bad), continuous (e.g., 0 to 1, −10 to 10, with computer precision of a floating point number or with a quantized on a fixed scale to a certain number of bits), vector (e.g., sound files, image files, etc.). Reducing a number of categories or precision for a given input or feature of a machine learning model may reduce computation complexity. Pre-processing of street images or map data may also reduce dimensionality of the machine learning model (e.g., a neural network).

An example training dataset may include different number of turns for each of the locations 320-326. The discrepancy in the numbers of aggregated right turn instances available for training at each of the four intersection may be due to the discrepancy in traffic patterns or the differences in the availability of traffic data to the data aggregation module 136. In some implementations, each maneuver (e.g., each instance of a right turn illustrated in FIG. 3) serves as a distinct data record for training the model. In other implementations, same turns at each location may be binned or aggregated together, e.g. by the data aggregation module 136. The data aggregation module 136 may evaluate for each bin the aggregate statistics of success. The data aggregation module 136 may separate bins by the conditions associated with each turn. For example, the data aggregation module 136 can aggregate right turns at a given location executed in the dark of the night in one bin, and aggregate the turns executed during the light of day in a different bin. The data aggregation module 136 may further subdivide the bins based on other conditions, that may include weather conditions, and/or any other suitable conditions.

The success rates for executing the right turns at each of the locations 320-326 and placed in the same bin may be different. Each success rate may be a number between 0 and 1 or a value between 0 and 100%. A success rate may have an associated indication of confidence that may depend on, for example, the number of turns used to estimate the success rate. The estimation of success rates is discussed in more detail below.

In some implementations, each instance of a maneuver is treated as a separate data record for the purpose of training a machine learning model. For example, if one hundred right turns are made at an intersection each one may be treated separately for training, rather than binned into categories. Each instance of a turn may have a binary categorization of success or failure, or may have various success categories including, for example, success without hesitation, hesitation, near miss, failure. A machine learning module 134 may train an machine-learning model to estimate a probability of each of these categories, as described in more details below.

Location data for each of the four locations 320-326 may serve as input for training and/or querying an machine-learning model. In some implementations, the machine learning module 134 may perform data-reduction analysis on the vector location data (e.g., satellite images, street-level imagery, traffic pattern data, other geo-spatial or map data) to extract, categorize, and/or quantify salient features. In other implementations, the data aggregation module 136 or another suitable system module may perform at least some of the data reduction analysis and store the reduced data in the location database 144. Salient features may include location classification (e.g., rural, urban), presence of and distance to difficult intersections, visibility of intersections, visibility of signage, and/or other suitable data. Salient features may be different for different maneuver classes or types. For example, with respect to visibility of signage, a street sign for the right turn at an intersection may be visible, but a street sign for the left turn at the same intersection may be obscured.

In classifying the location 320 for the right turn, the aggregation module 136 and/or the machine-learning module 134 may identify right turns onto the P^{t} street and the 3^{rd} street as potential distractor maneuvers. The distance between the preceding distractor (right on 3^{rd} street) and the intended maneuver (right on 2^{nd} street) may serve as one of the features descriptive of the intended maneuver. Analogously, the distance between the following distractor (right on 1st street) and the intended maneuver (right on 2^{nd} street) may serve as another one of the features descriptive of the intended maneuver. Additionally or alternatively, the distances to distractor maneuvers may be normalized to the speed limit and/or the approach speed. Furthermore, presence of distance to left turns as distractor maneuvers for the intended right turn may be included in right turn maneuver features.

The presence of and distances to distractor maneuvers for the illustrated right turns at locations 322-326 may be different from the equivalent features at location 320. After training a module with the training set, the machine-learning module 134 in some scenarios can quantify the influence of the distractor maneuver features on the probability of success in executing the intended maneuver. Furthermore, the machine-learning module 134 can quantify the effects of the distractor maneuver features in view of conditions at the time of maneuver execution. For example, the effect of the following distractor maneuvers (i.e., right on 1 ^{st}, right on Amazon, right on Paris) may be smaller when visibility is low.

In some implementations, the inputs to a machine-learning model may include location data in raw or substantially unreduced formats rather than the reduced features described above. For example, the location data may include roadway topology, satellite images, and/or street-level images. The images may be raw images, compressed images, and/or segmented images. With sufficient amount of training data, the machine-learning model may be trained to estimate success probability based on the more raw high-dimensionality vector location data along with other pertinent factors that do not necessarily include reduced features describing and quantifying distractor maneuver parameters.

In an example scenario, an operator, driving a car in the rain after dark at rush hour may be a minute (e.g., half a mile, going at 30 miles per hour or mph) away from the maneuver illustrated at location 320. The example input vector for the machine learning module may encompass the maneuver and location identifier (e.g., right on 2^{nd} St. from Main St.), the speed (e.g., 30 mph), the traffic conditions (e.g., 7 out of 10, 10 being heaviest), precipitation/degree (e.g., rain/3 out of 5, five being heaviest), lighting (2 out of 5, 5 being lightest), and familiarity of the driver with this location (3 out of 5, 5 being the most familiar). The machine learning module 134 can retrieve one or more machine learning models trained with a dataset comprising similarly structured input vectors. The machine learning module 134 can reduce location information (e.g., satellite image data, map data, etc.) in the training dataset and in the query data descriptive of the impending maneuver to a vector of location-specific descriptors (as described above) and append to the vector of condition-specific descriptors. The combined vector may be used in training one or more machine learning models and in generating the metric of probability.

In some implementations, the machine learning module 134 (or another suitable module of the navigation system) may cluster similar locations for each maneuver using a clustering algorithm based on similarities in success statistics for maneuver execution. For example, locations 322-326 may be clustered to the same cluster for the corresponding illustrated right turns. A machine learning model for generating a metric of probability may be trained separately for each cluster (i.e., location class generated by the clustering algorithm). Within each class, the different locations may be interrelated by correlation matrices that may be specific to each maneuver, to certain conditions, etc.

For the indicated right turns, the success statistics for location 320 may have correlations, for example, of 0.8, 0.7, and 0.9, to the success statistics at locations 322, 324, and 326 respectively. The different correlations may be due to the presence and arrangement of the maneuver, visibility of signage, and/or other factors. Thus, the statistics of maneuver success at location 326 may be determined to be somewhat more relevant than the other two locations for generating the expected probability of success for the intended maneuver. The trained machine learning model may reflect the correlations, particularly when the features distinguishing the locations are part of the location descriptions.

As discussed above, the system calculates a probability of success for a given right turn at location 320 in view of right turn statistics at multiple locations (including locations 320-326), taking into account the differences among the locations. In the subsequent discussion, more examples of location/maneuver combinations are illustrated.

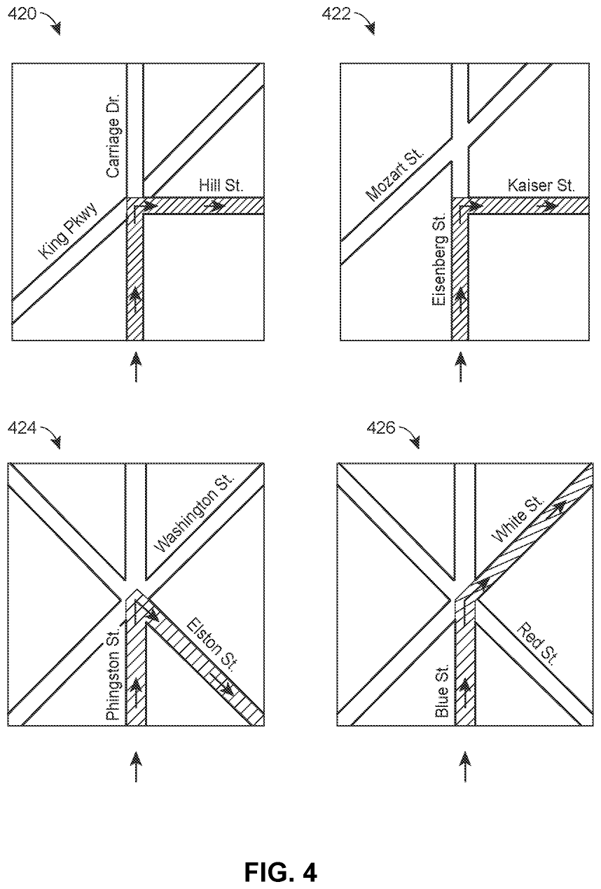

FIG. 4 illustrates a set of four right turn maneuvers at geographic locations 420-426 that have similarities in roadway layouts and the associated maneuvers. In some implementations all four of the maneuvers would be classified as right turns. In other implementations, the maneuvers at location 420 and 422 may be classified as normal right turns, while the maneuvers at locations 424, 426 may be classified as sharp and slight right turns, respectively.

A machine learning module (e.g., the machine learning module 134) may classify all four locations 420-426 as similar locations for the context of a right turn, the unifying feature being the presence of more than four corners at an intersection. In some implementations, location 422 may be classified in a separate class, as a T-intersection. In other implementations, locations 420 and 422 may be classified together with each other, but separately from the location 424 and 426. Again, for the locations that are classified as similar locations in the context of an intended maneuver (e.g., right turn, in this case), a machine learning model may be trained for determining a metric of probability of success in executing the maneuver. In some implementations, the features of the intersections (e.g., presence and relative position of a difficult turn) may serve as input vectors in a machine learning model.

The different features of the right turns executed at locations 420-426 may include angle of turn (e.g., normal, slight, sharp, or a turn angle), indication of difficult turns (e.g., high, medium, or low confusion factor, or a quasi-continuous indicator), position of confounding turns (e.g., preceding or following and/or relative distance and angle). The navigation system may perform feature extraction and analysis using, for example, the data aggregation module 136, the machine learning module 134, any other suitable module or a combination of modules.

A machine learning module (e.g., the machine learning module 134) may also determine the probability metric without classifying intersection topology and/or explicit feature extraction, instead, training a machine learning model based on all the right turns, or even broader, all the maneuvers. In such implementation, vector data with a satellite image or a map data subset corresponding to the location data (with margins as discussed above) may serve as a part of the input for training a machine learning model and/or for evaluating the model for the maneuver of interest.

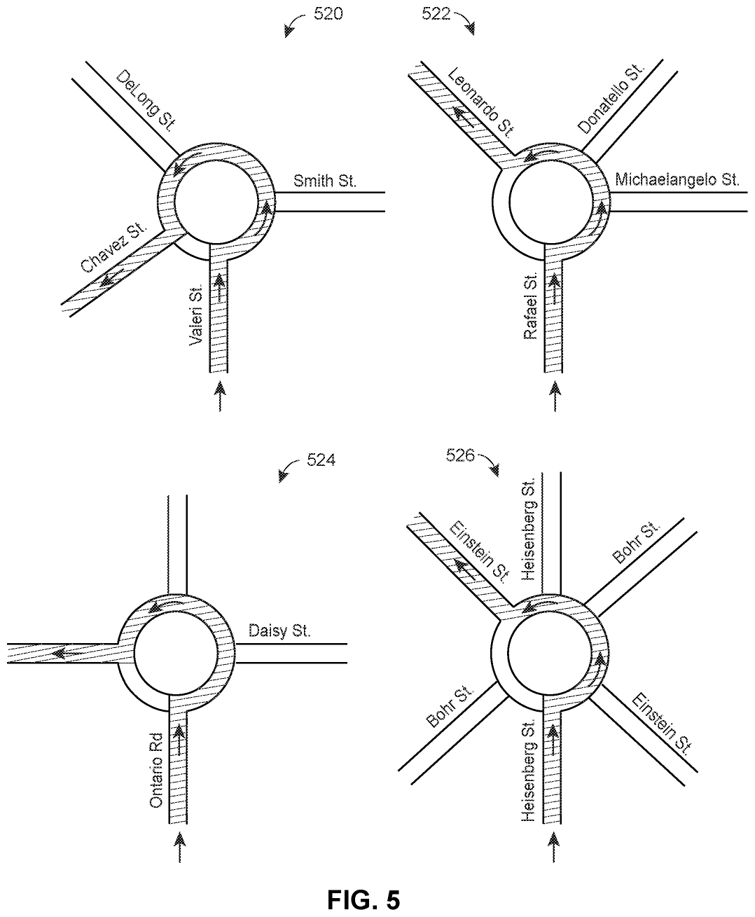

FIG. 5 illustrates a set of four left turn maneuvers at geographic locations 520-526 that include traffic circles. In some implementations, the metric of probability of success for executing a left turn at a traffic circle may be computed in view of success statistics for other similar maneuvers. Analogously to other classified maneuvers, a dedicated machine learning model for left turns (or just turns) at traffic circles may be pre-trained and invoked for generating the metric of probability. A feature set for a traffic circle may include: a total number (and/or angular positions) of radial exits from a traffic circle and the index of the exit for the intended maneuver (e.g., 3, 3, 3, and 4, corresponding, respectively, to locations 520, 522, 524, and 526).

Some maneuvers may more significantly decrease the probability of executing the maneuver with a specific set of instructions and/or under different conditions. The DeLong St. may be more difficult for the turn on Chavez St. (both at location 520) than Donatello St. to the turn on Leonardo St. (both at location 522) because both streets at location 520 are left turns with respect to the approach direction, while Donatello St. at location 522 is a right turn. Nevertheless, all statistics at the locations 520-526 may affect the generated metric of probability of a successful maneuver at any one of the locations 520-526, at least in part by contributing to the training set for the machine learning model.

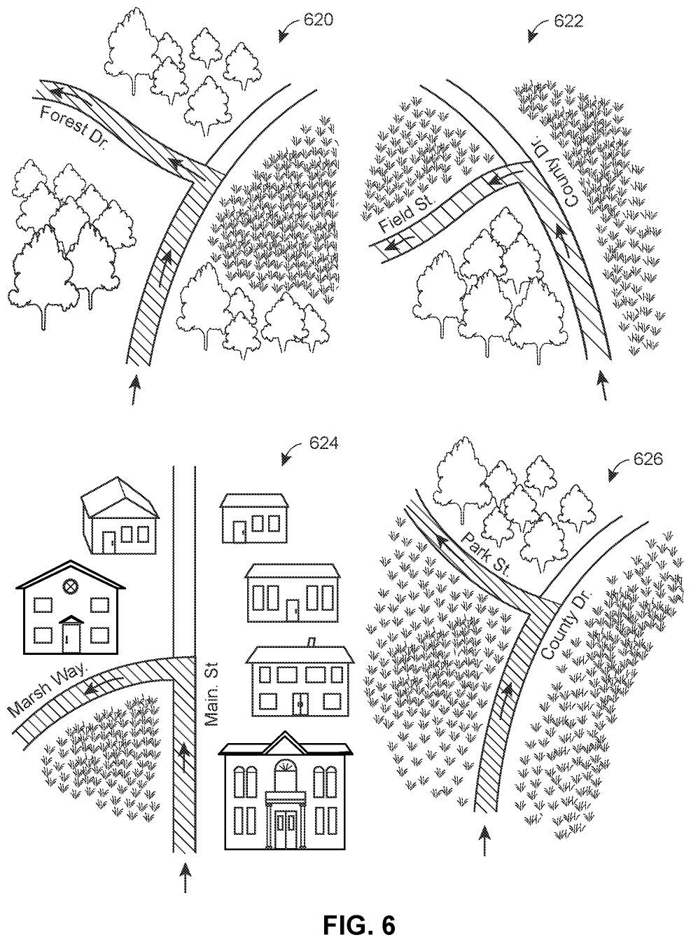

The discussion of FIGS. 3-5 focused on location similarities for different maneuvers based on map data (i.e., road layout, etc.). FIG. 6, on the other hand, illustrates a set of four left turn maneuvers at geographic locations 620-626, where terrain information is indicated at the locations. A data aggregation module 136 and/or the machine learning module may extract terrain information from satellite images or from other another suitable source. The terrain information may be used as additional features in training and/or evaluating the one or more machine learning models for generating an indication of probability of success for a given maneuver. For example, a forested area within approaches to the turns onto the Forest Dr. at location 620 and onto Field St. at location 622 may obscure the approaching left turn from view and/or indicate reduced light at dusk. On the other hand, fields within approaches to Marsh Way at location 624 and Park St. at location 626 may indicate a clear view of the turn, particularly during the times that the vegetation in the fields may be assumed to be low. Furthermore, the residential area at location 624 may indicate that lighting from artificial lights may improve visibility when the sun is below the horizon. Therefore, assimilating terrain information, whether through raw satellite imagery or through classified terrain data may yield more accurate machine learning models. Thus, a dataset descriptive of locations may include satellite imagery and/or map data to configure one or more machine learning models.

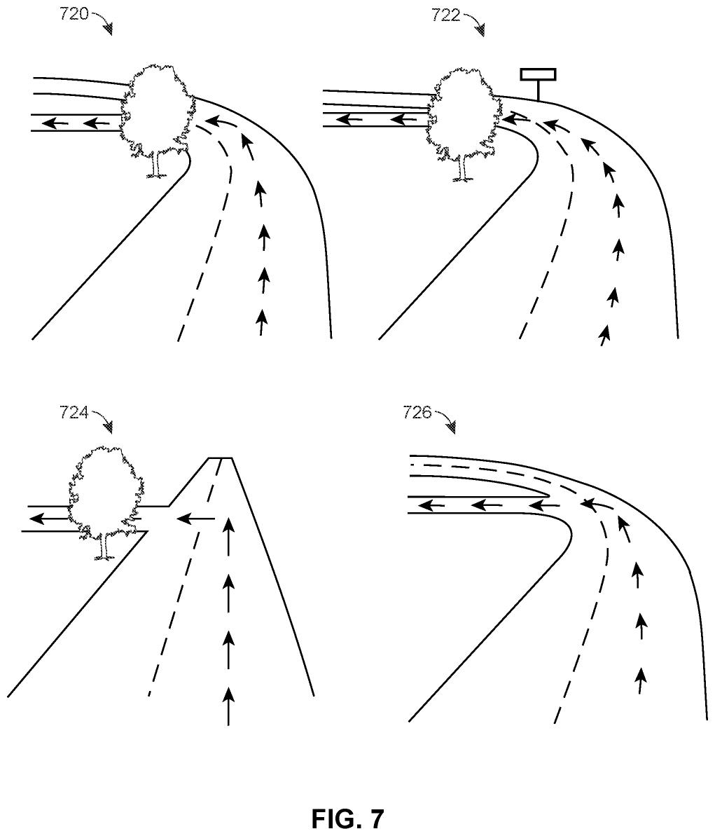

FIG. 7 illustrates four street-level frames 720-726 corresponding to a set of similar left turn maneuvers at similar locations. At least some of the street-level imagery may be obtained using portable system (e.g., using sensors 128 of the portable system 20). For example, as discussed above, camera and/or lidar system data may help generate and/or classify street-level images.

As with satellite imagery and/or map data discussed above, the set of four is chosen only to simplify the discussion. In some implementations, street-level frames 720-726 may represent a subset of a set of similar locations pre-selected by a clustering and/or classifying pre-processing algorithm. A machine learning model may be trained with a set of dozens, hundreds, thousands, tens of thousands, millions (i.e., any suitable number) of similar locations. Nevertheless, FIG. 7 helps illustrate an example use of street-level imagery indicative of plurality of locations in configuring a machine learning model.

In some implementations, the vectors obtained from the street-level frames 720-726 may be added directly as features descriptive of the left turns at the corresponding locations. In other implementations, the street-level frames and/or sequences of street-level frames may be mined for information. For example, the street-level frames may be segmented and classified to extract a variety of features including visibility of landmarks and/or ques (e.g., turn visibility, presence of obscurants, presence and visibility of signs, etc.), as well as information about short-lived or more permanent conditions associated with the location (e.g., road quality, nearby construction, presence of distractors, etc.). The extracted features may be used to predict the difficulty and/or success probability of a given maneuver.

For example, in frame 720, a left turn is marked by a sequence of arrows. From the frame 720, the curvature of the road is clearly visible, and the navigation system may extract a metric of curvature (e.g., using the machine learning module 134, the data aggregation module 136, and/or the processing unit 122 of the portable system 20). Likewise, the navigation system may extract the metric of curvature from frame 722 associated with a similar location with respect to a left turn. The analysis of frames 720 and 722 may reveal additional similarities and differences of the locations with respect to the left turn. For example, a feature corresponding to visibility of the intersections or distances from which the intersections are visible may be similar for the two locations due to the presence of the trees that obscure the junctions (at least for some distances from the intersection) at both locations. Additional analysis, that may include analysis of street-level images, satellite images, and/or climate data, may reveal that the effect on visibility may be seasonal, varying with the presence of foliage. Further analysis of the street-level frames 720 and 722 may extract a presence of a sign in frame 722 and the absence of a corresponding sign in frame 720. While the features described above may be determined in pre-processing, the statistical effect of the extracted features on the generated maneuver difficulty and/or probability of successfully executing a maneuver may be determined through training of the machine learning model.

The frames 724 and 726 illustrate street-level frames associated with left turn maneuvers at similar locations (e.g., similar road geometry) to the maneuvers associated with frames 720 and 722. The navigation system may use the frames 724 and 724 to extract features of the locations that make the locations similar and/or different from the locations of frames 720 and 722. For example, the navigations system may analyze frame 724 to determine that the road curvature is different (more straight) from other frames in FIG. 7, and though there is a tree partially obscuring the intersection, the range at which the intersection is visible may be different from the corresponding feature in frames 720 and 722. On the other hand, frame 736 may indicate a similar road curvature to the ones in frames 720 and 722, but an absence of an object obscuring the intersection.

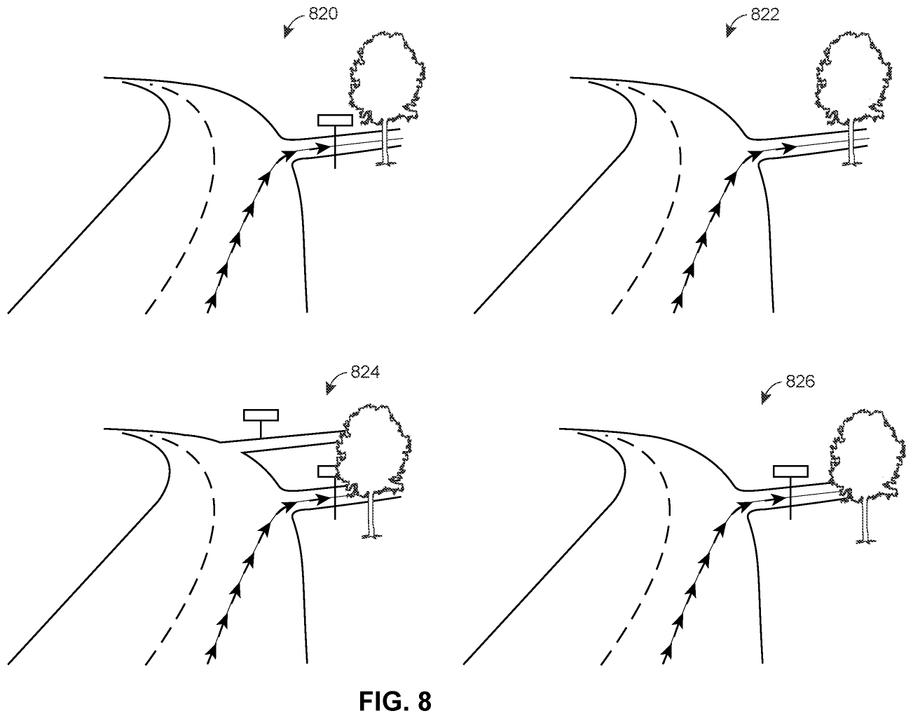

FIG. 8, like FIG. 7, illustrates four street-level frames 820-826, but in the context of four similar right turns. A number of features may be extracted from the frames 820-826, including presence of signs, visibility of signs, and presence of difficult intersections. One extracted feature may include an indication of a street sign: present in all but frame 822. Another feature may be the visibility of a sign: good in frames 820 and 826, but partial frame 824. Yet another feature may be presence (and/or a distance to) of a difficult intersection, as in frame 824. The difficult intersection may lead a vehicle operator to turn early or miss a turn. A timely reminder or a use of a landmark in directions (e.g., provided by the navigation module 132) may facilitate a maneuver.

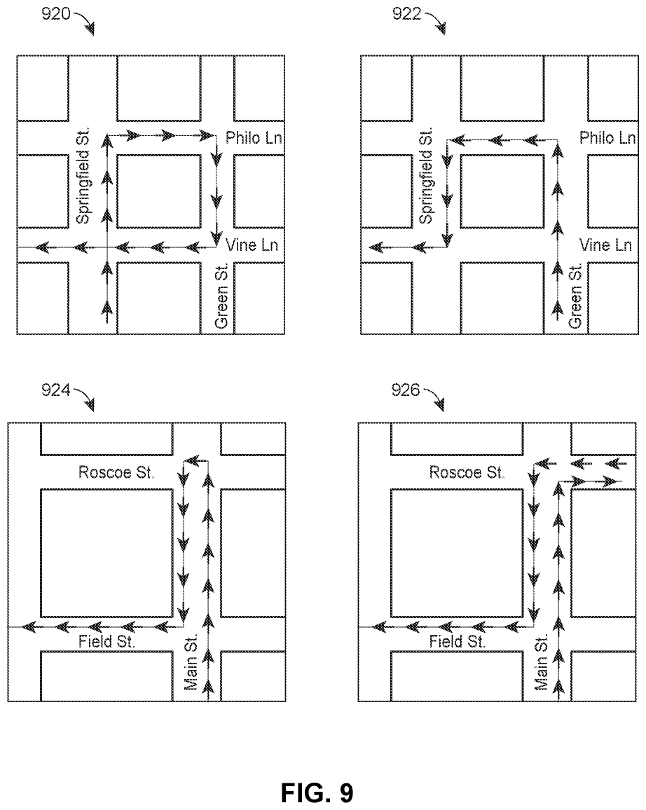

FIG. 9 illustrates four remediation maneuvers 920-926 that may be executed by vehicle operators in the aftermath of missing a left turn. The maneuvers 920-926 may be detected by one or more sensors disposed within a vehicle (e.g., sensors in the portable system 20) and/or sensors (e.g., V2I 164) disposed within the infrastructure through which a vehicle operator is navigating. In some scenarios, the navigation system of FIG. 1 detects the remediation maneuvers 920-926 when the operators follow certain navigation instructions, fail to follow the navigation instructions for a certain maneuver, and return or (or merge into) the original route after the navigation system provides the updated instructions. In other scenarios, when the operator is not currently following directions from the navigation system but indicates that the navigation system may use his or her location data for these purposes, the navigation system detects a loop (the maneuver 920), a U-turn or a longer turn-around (maneuvers 924 and 926), superfluous maneuvering (maneuver 922), and determines that the user probably missed the turn he or she intended to make.

In some implementations and/or situations, the navigation system may not detect the paths of the remediation maneuvers 920-926. On the other hand, even a short remediation maneuver may contribute to the time it takes to execute a maneuver. Detecting a time it takes to execute a maneuver as a feature of the maneuver may contribute to training the corresponding machine learning model and to generating the metric of difficulty for the maneuver.

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

1. A method of providing navigation instructions, the method comprising:
receiving, by one or more processors, a dataset descriptive of a plurality of locations and a set of one or more maneuvers attempted by one or more vehicles at the plurality of locations;
training, by the one or more processors, a machine-learning model using the dataset, to
configure the machine-learning model to generate metrics of difficulty for the set of maneuvers;
receiving, by the one or more processors, a query data including indications of (i) a location and (ii) a maneuver to be executed by a vehicle at the location;
applying, by the one or more processors, the query data to the machine-learning model to generate a metric of difficulty for the maneuver; and
providing, by the one or more processors via a user interface, a navigation instruction for the maneuver, including selecting at least one parameter of the navigation instruction based on the generated metric of difficulty.

2. The method of claim 1, wherein selecting the at least one parameter based on the generated metric of difficulty includes:
selecting a higher level of detail for the navigation instruction when the metric of difficulty exceeds a difficulty threshold, and
selecting a lower level of detail for the navigation instruction when the metric of difficulty does not exceed the difficulty threshold.

3. The method of claim 1, wherein:
the at least one parameter includes a time interval between the providing the navigation instruction and the vehicle reaching the location, and
selecting the at least one parameter based on the generated metric of difficulty includes:
selecting a longer time interval when the metric of difficulty exceeds the difficulty threshold, and
selecting a shorter time interval when the metric of difficulty does not exceed the difficulty threshold.

4. The method of claim 1, wherein selecting the at least one parameter includes determining whether the navigation instruction is to include a visual landmark based on the generated metric of difficulty.

5. The method of claim 1, wherein:
receiving the dataset includes receiving at least one (i) satellite imagery or (ii) street-level imagery for the plurality of locations and the location indicated in the query; and
the machine-learning model generates the metric of difficulty for the set of maneuvers in view of visual similarities between locations.

6. The method of any claim 1, wherein:
receiving the dataset includes receiving at least one of (i) satellite imagery, (ii) map data, or (iii) vehicle sensor data for the plurality of locations and the location indicated in the query;
training the machine-learning model includes applying, by the one or more processors, a feature extraction function to the data set to determine road geometry at the corresponding locations; and
the machine-learning model generates the metric of difficulty for the set of maneuvers in view of similarities in road geometry between locations.

7. The method of any claim 1, wherein:
receiving the dataset includes receiving indications of how long the one or more vehicles took to complete the corresponding maneuvers; and
the machine-learning model generates the metric of difficulty for the maneuver in view of relative durations of the maneuvers at the respective locations.

8. The method of any claim 1, wherein:
receiving the dataset includes receiving indications of navigation routes the one or more vehicles followed when attempting the corresponding maneuvers; and
the machine-learning model generates the metric of difficulty for the set of maneuvers in view of whether the vehicles completed or omitted the corresponding maneuvers.

9. The method of any claim 1, wherein the indication location is not referenced in the dataset.

10. The method of any claim 1 implemented in a user device, wherein receiving the dataset includes receiving the dataset from a network server.

11. The method of any claim 1 implemented in a network server, wherein providing the navigation instruction via the user interface includes sending the navigation instruction to a user device for display via the user interface.

12. A system comprising:
processing hardware; and
non-transitory computer-readable memory storing thereon instructions which, when executed by the processing hardware, cause the system to
receive a dataset descriptive of a plurality of locations and a set of one or more maneuvers attempted by one or more vehicles at the plurality of locations,
train a machine-learning model using the dataset, to configure the machine-learning model to generate metrics of difficulty for the set of maneuvers,
receive a query data including indications of (i) a location and (ii) a maneuver to be executed by a vehicle at the location,
apply the query data to the machine-learning model to generate a metric of difficulty for the maneuver, and
provide, via a user interface, a navigation instruction for the maneuver, including selecting at least one parameter of the navigation instruction based on the generated metric of difficulty.

13. A method in a user device for providing navigation instructions, the method comprising:
receiving, by processing hardware via a user interface, a request to provide navigation instructions for traveling from a source to a destination;
obtaining, by the processing hardware, a navigation route from the source to the destination, the navigation route including a maneuver of a certain type at a location for which data descriptive of past maneuvers performed at the location is unavailable;
providing, by the processing hardware, a navigation instruction for the location, with at least one parameter of the navigation instruction modified in view of a level of difficulty of the maneuver, the level of difficulty determined based on one or more metrics of similarity of the maneuver to maneuvers of the same type performed at other locations.

14. The method of claim 13, wherein the at least one parameter modified in view of the level of difficulty is a level of detail of the navigation instruction.

15. The method of claim 13, wherein the at least one parameter modified in view of the level of difficulty is a time interval between the providing the navigation instruction and the vehicle reaching the location.

16. A method in a user device for providing navigation instructions, the method comprising:
receiving, by processing hardware via a user interface, a request to provide navigation instructions for traveling from a source to a destination;
obtaining, by the processing hardware, a navigation route from the source to the destination, the navigation route including navigation instructions as provided by.

17. A method in a network server for providing navigation instructions, the method comprising:
receiving, by processing hardware from a user device, a request to provide navigation instructions for traveling from a source to a destination;
generating, by the processing hardware, a navigation route from the source to the destination, the navigation route including a maneuver of a certain type at a location for which data descriptive of past maneuvers performed at the location is unavailable;
determining, by the processing hardware, one or more metrics of similarity of the maneuver to maneuvers of the same type performed at other locations;
determining, by the processing hardware, a level of difficulty of the maneuver based on the one or more metrics of similarity; and
generating, by the processing hardware, a navigation instruction for the location, with at least one parameter of the navigation instruction modified in view of the level of difficulty of the maneuver.
